(19) United States
(12) Patent Application Publication
(10) Pub. No.: US 2007/0098118 A1
(43) Pub. Date: May 3, 2007

(54) Method for automatic gain control (AGC) by combining if frequency adjustment with receive path gain adjustment

(76) Inventors: Khurram Muhammad, Richardson, TX (US); Moderage Chandana Fernando, Plano, TX (US); Imtinan Elahi, Richardson, TX (US); Dirk Robert Walter Leipold, Plano, TX (US)

Correspondence Address: TEXAS INSTRUMENTS INCORPORATED, P O BOX 655474, M/S 3999, DALLAS, TX, 75265, US

(21) Appl. No.: 11/264,442

(22) Filed: Nov. 1, 2005

(51) Int. Cl. H04L 27/06; H04L 27/08

(52) U.S. Cl. 375/344; 375/345

(57) ABSTRACT

In a method and system for performing automatic gain control (AGC) in a receiver, an automatic integrated controller (AICTR) device includes a gain controller (GC) to control an amplitude of an input signal provided to the receiver, with the interfering signal and the signal of interest being included in the input signal. The GC maintains the amplitude within a predefined range to operate the receiver substantially close to saturation. The AICTR device also includes a frequency controller (FC) to control a frequency of a local oscillator (LO) signal. The LO signal is mixed with the input signal to generate an intermediate frequency (IF) signal. The FC changes the frequency of the LO signal to increase or decrease a frequency of the IF signal. A greater attenuation is provided to the interfering signal compared to an attenuation for the signal of interest by the reduction in frequency of the IF signal.

### BACKGROUND

The present disclosure relates generally to the field of data communications, and more particularly to an improved system and method for performing automatic gain control (AGC) in a communication device.

The basic operation of a communication system is well known in the art. The communication system typically includes a transmitter and a receiver operating cooperatively to convey data and/or information from an operator of the transmitter to a user of the receiver via a communications media. The media may be wired and/or wireless.

Multiple technological standards may be adopted for use in wireless media applications. For example, IEEE 802.11, Bluetooth, Global System for Mobile Communications (GSM), and Infrared Data Association (IrDA) are widely accepted standards for wireless communications. Regardless of the standard used, wireless devices typically operate in certain predefined frequency spectra.

A receiver typically includes a downconverter component and a demodulator component. In the downconverter, the received signal having a predefined carrier frequency is received and converted to a lower intermediate frequency (IF) signal that may be more suitable for the demodulator. The IF signal is then typically: 1) filtered to select the signal of interest and reject unwanted signals, 2) amplified by a baseband amplifier, and 3) digitized by an analog-to-digital converter (ADC). The demodulation, which may include complex demodulation algorithms, is typically performed in the digital domain by a digital signal processor (DSP).

Two well known topologies for receiver circuits include the heterodyne and the homodyne receiver. Heterodyne receivers typically include a downconversion to an IF signal, whereas homodyne receivers typically do not include an IF signal. Thus, heterodyne and homodyne receivers are often referred to as IF and zero-IF receivers, respectively. Homodyne receiver circuits are typically more compact and hence may be better suited to be implemented as an integrated circuit (IC) chip compared to a traditional heterodyne receiver circuit, which typically includes bulky components. Although full integration is desirable for cost reduction, the use of homodyne receivers have been limited in the past due to the poor performance compared to traditional heterodyne receivers. More recently, a low IF receiver circuit, which combines a high level of integration with a higher performance, is increasingly being used in communication systems.

Some of the traditional heterodyne, homodyne and low IF topology based receivers are described in further detail in the following technical papers and U.S. patents, which are hereby incorporated herein by reference into this specification: 1) ‘A Discrete Time Quad-band GSM/GPRS Receiver in a 90 nm Digital CMOS Process’, K. Muhammad, Y.-C. Ho, T. Mayhugh, C.-M. Hung, T. Jung, I. Elahi, C. Lin, I. Deng, C. Fernando, J. Wallberg, S. Vemulapalli, S. Larson, T. Murphy, D. Leipold, P. Cruise, J. Jaehnig, M.-C. Lee, R. B. Staszewski, R. Staszewski and K. Maggio, IEEE Custom Integrated Circuits Conference, Sep. 18-21, 2005, San Jose, Calif., 2) ‘Low-IF Topologies for High-Performance Analog Front Ends of Fully Integrated Receivers’, Jan Crols and Michiel S. J. Steyaert, IEEE Transactions On Circuits And Systems-II: Analog And Digital Signal Processing, Vol. 45, No. 3, March 1998, and 3) U.S. Pat. No. 6,882,208, Suissa et al., entitled ‘Adjustment Of Amplitude And DC Offsets In A Digital Receiver’.

However, current AGC techniques typically adjust only the gain of the receive path, e.g., path of the received signal, in order to extend the dynamic range of the receiver and avoid receiver saturation. This imposes stricter margins on the receiver gain path when considering process and temperature variations.

Therefore, a need exists to provide an improved method and system for performing AGC in a communications device. Specifically, there is a need for an improved AGC control device in a receiver that provides improved integration, higher performance, and improved filtering of unwanted signals without saturating the receiver. Accordingly, it would be desirable to provide an efficient method and system for performing AGC to eliminate the disadvantages found in the prior techniques discussed above.

### SUMMARY

The foregoing need is addressed by the teachings of the present disclosure, which relates to an improved method and system for adjusting gain controls of a receiver. According to one embodiment, in a method and system for performing automatic gain control (AGC) in a receiver, an automatic integrated controller (AICTR) device includes a gain controller (GC) to control an amplitude of an input signal provided to the receiver, with the interfering signal and the signal of interest being included in the input signal. The GC maintains the amplitude within a predefined range to operate the receiver substantially close to saturation. The AICTR device also includes a frequency controller (FC) to control a frequency of a local oscillator (LO) signal. The LO signal is mixed with the input signal to generate an intermediate frequency (IF) signal. The FC changes the frequency of the LO signal to increase or decrease a frequency of the IF signal. A greater attenuation is provided to the interfering signal compared to an attenuation for the signal of interest by the reduction in frequency of the IF signal.

In one aspect of the disclosure, a method for performing automatic gain control (AGC) in a receiver includes adjusting a gain of an input signal received by the receiver to operate the receiver substantially close to saturation. The input signal includes an interfering signal and a signal of interest. An intermediate frequency (IF) of the receiver is reduced to provide greater attenuation to the interfering signal compared to an attenuation for the signal of interest.

Several advantages are achieved by the method and system for controlling gain of a receiver according to the illustrative embodiments presented herein. The embodiments advantageously provide for more robust margins on the receiver path gain when considering process and temperature variations. In addition, the embodiments advantageously provide the benefit of reducing the level of the largest interferers while decreasing the noise figure of the receiver, thereby allowing a potential decrease in the receiver gain without increasing the original noise figure of the receiver.

### BRIEF DESCRIPTION OF THE DRAWINGS

FIG. 1 illustrates a block diagram of a receiver, according to an embodiment;

FIG. 2 is a graphical diagram illustrating amplitude versus frequency response characteristics of a receiver, according to an embodiment;

FIG. 3 is a block diagram of an integrated receiver, according to an embodiment; and

FIG. 4 is a flow chart illustrating a method for performing automatic gain control (AGC) in a receiver, according to an embodiment.

### DETAILED DESCRIPTION

Novel features believed characteristic of the present disclosure are set forth in the appended claims. The disclosure itself, however, as well as a preferred mode of use, various objectives and advantages thereof, will best be understood by reference to the following detailed description of an illustrative embodiment when read in conjunction with the accompanying drawings. The functionality of various circuits, devices or components described herein may be implemented as hardware (including discrete components, analog, digital and/or mixed circuits, integrated circuits and systems-on-a-chip ‘SoC’), firmware (including application specific integrated circuits and programmable chips) and/or software or a combination thereof, depending on the application requirements.

The following is a glossary of terms used in this disclosure:

| Term | Description |
|---|---|
| ABE | Analog Back End |
| A/D | Analog to Digital |
| ADC | Analog/Digital Converter |
| AFE | Analog Front End |
| AGC | Automatic Gain Control |
| AICTR | Automatic Integrated Controller |
| BER | Bit Error Rate |
| BPF | Band Pass Filter |
| BTS | Base Transceiver Stations |
| CDMA | Code-division Multiple Access |
| CTA | Continuous Time Amplifier |
| dBm | decibel milliwatts |
| DC | Direct Current |
| DRX | Digital Receiver |
| DSP | Digital Signal Processor |
| FC | Frequency Controller |
| GC | Gain Controller |
| GPS | Global Positioning System |
| GSM | Global System for Mobile Communications |
| HB | High Band |
| IC | Integrated Circuit |
| IF | Intermediate Frequency |
| I/Q | I channel and Q channel |
| LB | Low Band |
| LNA | Low Noise Amplifier |
| LPF | Low Pass Filter |
| LPFC | Low Pass Filter Controller |
| LO | Local Oscillator |
| MHz | Megahertz |
| MTDSM | Multi-Tap Direct-Sampling Mixer |
| OCP | Open Core Protocol |
| QOS | Quality of Service |
| RF | Radio Frequency |
| RSSI | Receive Signal Strength Indicator |
| SDADC | Sigma Delta Analog/Digital Converter |
| SDC | Sigma Delta Converter |
| SoC | Systems-on-a-chip |
| TA | Transconductance Amplifier |
| TA/MIX | Transconductance Amplifier/Mixer |
| TDMA | Time-division Multiple Access |
| VGA | Variable Gain Amplifier |

Traditional automatic gain control (AGC) mechanism typically adjusts only the gain of the receive path in order to extend the dynamic range of the receiver. For low power signals (e.g., at sensitivity) it provides maximum gain in the receiver. As the input signal of interest increases in amplitude/energy, it reduces the receiver gain so that an adjacent blocker does not saturate the receive path. Generally, only the receiver gain is adjusted to prevent receiver saturation, which imposes stricter margins of the gain when considering process and temperature variations. These problems may be addressed by an improved system and method for controlling gain of a receiver. In an improved method and system for performing automatic gain control (AGC) in a receiver, an intermediate frequency (IF) of the receiver is reduced to provide greater attenuation to the interfering signal compared to an attenuation for the signal of interest.

According to one embodiment, in a method and system for performing automatic gain control (AGC) in a receiver, an automatic integrated controller (AICTR) device includes a gain controller (GC) to control an amplitude of an input signal provided to the receiver, with the interfering signal and the signal of interest being included in the input signal. The GC maintains the amplitude within a predefined range to operate the receiver substantially close to saturation. The AICTR device also includes a frequency controller (FC) to control a frequency of a local oscillator (LO) signal. The LO signal is mixed with the input signal to generate an intermediate frequency (IF) signal. The FC changes the frequency of the LO signal to increase or decrease a frequency of the IF signal. A greater attenuation is provided to the interfering signal compared to an attenuation for the signal of interest by the reduction in frequency of the IF signal.

As described earlier, regardless of the standard used, wireless devices such as radio frequency (RF) transceivers (e.g., receiver and transmitter combined in one device) typically operate in certain predefined frequency spectra. For example, a mobile phone that is compliant with the GSM 900 technical standard uses a radio transceiver operating in a 900 megahertz (MHz) radio frequency band and a quad band cellular phone that is compliant with the GSM850, EGSM900, DCS1800 and PCS1900 standard may include a transceiver operable to receive RF signals in the 800 to 1000 MHz and 1800 to 2000 MHz range. The receiver and/or transmitter may be included as a part of another circuit or device such as a microprocessor, a digital signal processor, a radio frequency integrated circuit, and/or a microcontroller.

The standards also typically define power levels for transmit and receive signals to maintain desired signal strength, minimum signal-to-noise ratio (SNR) for the receiver, and/or quality of service (QOS). The QOS may be defined by a maximum allowable bit error rate (BER) for the RF signal. For example, according to the Bluetooth standard in a modulated RF input signal at −70 decibel milliwatts (dBm) power level, the data output of the receiver may not have a bit error rate (BER) exceeding 10⁻³. The GSM standard defines five classes of mobile stations according to their peak transmitter power, e.g., 20, 8, 5, 2, and 0.8 watts. To minimize co-channel interference and to conserve power, both the mobiles and the Base Transceiver Stations (BTS) operate at the lowest possible power level while maintaining an acceptable signal strength and QOS. Power levels may be stepped up or down by adjusting receiver gain and hence an amplitude of the signal in steps of 2 dB from the peak power for the class down to a minimum of 13 dBm (20 milliwatts).

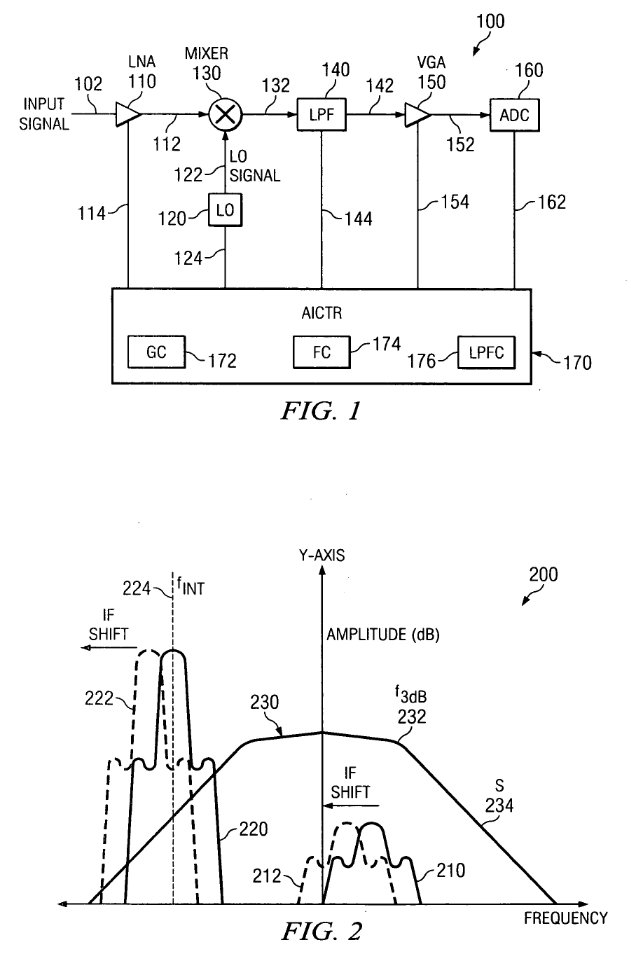

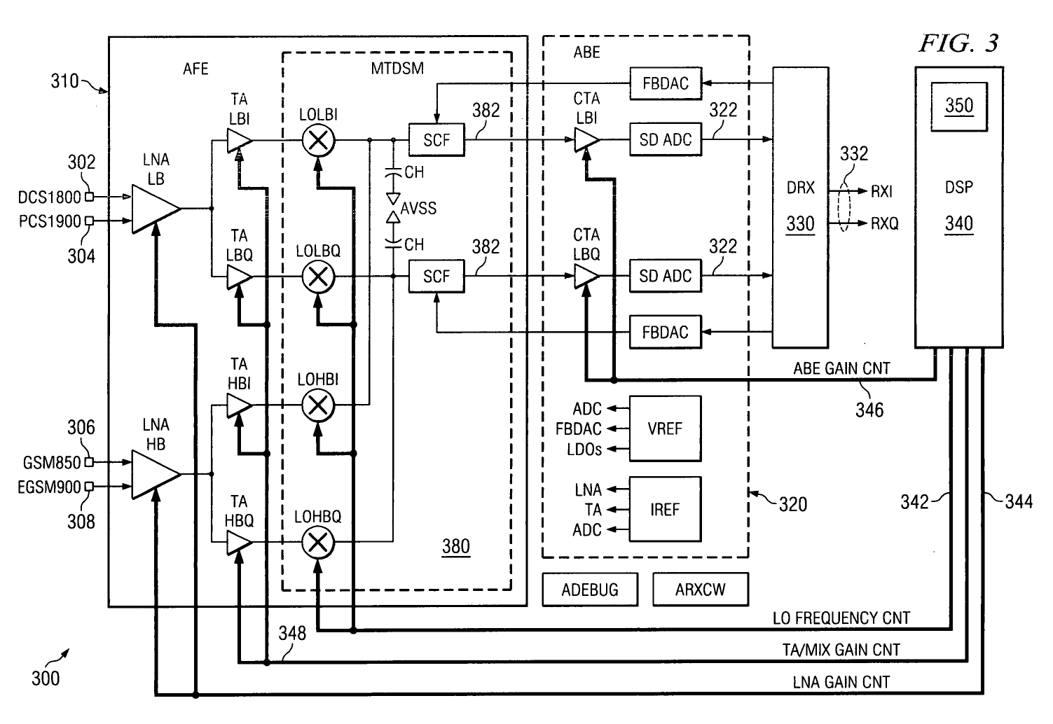

FIG. 1 illustrates a block diagram of a receiver 100, according to an embodiment. The receiver 100 includes techniques for adjusting intermediate frequency (IF) f_{IF} and gain to improve receiver performance without saturating the receiver. Although the receiver 100 is described using analog function blocks, it is understood that the receiver 100 may be implemented using various alternative technologies such as analog signal processing, digital domain signal processing, mixed signal processing and/or a combination thereof. For example, a filter block may be implemented in an analog form using continuous-time or discrete-time RF signals or as a digital filter using binary signals. Additional details of a digital receiver architecture for adjusting intermediate frequency (IF) f_{IF} and gain to improve receiver performance without saturating the receiver is described with reference to FIG. 3.

In the depicted embodiment, a low noise amplifier (LNA) 110 receives an input signal 102. The input signal 102, which may include one or more RF bands, includes a signal of interest at a carrier frequency f_{c} and one or more interfering or unwanted signals.

In a non-depicted, exemplary embodiment, the input signal 102 may be received from an antenna coupled to the receiver 100 and filtered by a front end band pass filter (BPF) to remove high frequency signals. The BPF serves to protect the receiver 100 from saturation by interfering signals at the antenna. Receiver saturation may be described as a condition or an operating state of the receiver 100 in which a further increase in one variable such as gain produces no further increase in the resultant effect such as the output signal. Receiver saturation generally occurs at higher power levels of interfering signals compared to the desired signal. In the depicted embodiment, the LNA 110 provides an amplified input 112 in response to the input signal 102. In a particular embodiment, a gain of the LNA 110 is controlled by a LNA control signal 114.

A local oscillator (LO) 120 provides a LO signal 122 having a variable frequency. The variable frequency of the LO signal 122 is controlled by a LO control signal 124. A mixer 130 is operable to downconvert the signal of interest from its carrier frequency f_{c} to a lower intermediate frequency (IF) having the frequency f_{IF}. The down-conversion process may utilize a difference between the mixer 130 RF input (the amplified input 112) and local oscillator input (LO) (LO signal 122) where for a low side injection the LO signal 122 is less than the RF signal (the IF frequency f_{IF} is positive) and for a high side injection the LO signal 122 is greater than RF signal (IF frequency f_{IF} is negative). That is, the mixer 130 mixes the signal of interest received as the amplified input 112 and the LO signal 122 to provide an intermediate frequency (IF) signal 132 having the frequency f_{IF}. In a non-depicted, exemplary embodiment, the IF signal 132 includes the signal of interest at a frequency f_{c} and an interfering signal. The frequency f_{IF} may be adjusted to any value ranging from +f_{IF} to −f_{IF}, including 0. Although a single IF downconversion stage is shown, it is understood that multiple downconversion stage IF's may be deployed in receivers.

In the depicted embodiment, a low pass filter (LPF) 140 centered around the IF frequency receives the IF signal 132 and provides a filtered IF signal 142 after filtering out at least one of the interfering signal. In a particular embodiment, the LPF 140 is a real low pass filter such as a Butterworth filter. The LPF 140 has predefined filter response characteristics such as corner frequency, slope and bandwidth. The response characteristics of the LPF 140 are controlled by a LPF control signal 144. Additional details of the response of the signal of interest and the interfering signal to a reduction in IF is described with reference to FIG. 2.

In the depicted embodiment, a variable gain amplifier (VGA) 150 receives the filtered IF signal 142 and provides an amplified filtered IF signal 152 having an amplitude/energy within a predefined range. A gain factor of the VGA 150 is controlled by a VGA control signal 154. The amplitude/energy of the amplified filtered IF signal 152 may be varied within the predefined range to maintain desired signal strength and/or quality of service (QOS) in response to changes in the input signal 102.

In the depicted embodiment, an analog to digital (A/D) converter (ADC) 160 converts the amplified filtered IF signal 142 into a digital signal 162. In a non-depicted, exemplary embodiment, the ADC 160 may be implemented as a delta sigma signal converter. Although the amplified filtered IF signal 142 is illustrated as a non-quadrature baseband A/D conversion, it is understood that alternative receiver architectures such as receiver with quadrature baseband A/D conversion and zero-IF or low-IF direct conversion with quadrature A/D conversion are contemplated.

In the depicted embodiment, an automatic integrated controller (AICTR) 170 monitors the digital signal 162. The digital signal 162 may include data and/or information indicative of the QOS and/or signal strength such as a received signal strength indicator (RSSI). The RSSI may be identified by a particular bit sequence of the digital signal. 162. In a particular embodiment, the AICTR 170 includes a gain controller (GC) 172 for controlling amplitude of an input signal 102 by maintaining the amplitude within a predefined range, a frequency controller (FC) 174 to control a frequency of a local oscillator (LO) signal 122, and a low pass filter controller (LPFC) 176 to control LPF 140 filter characteristics such as corner frequency and/or roll-off slope. The gain controller 172 may control gain factors for one or more amplifiers included in the receiver 100.

Specifically, the AICTR 170 provides the LO control signal 124 to adjust the variable frequency of the LO signal 122, the LNA control signal 114 to adjust a gain of the LNA 110, the VGA control signal 154 to adjust the amplitude of the filtered IF signal 142, and the LPF control signal 144 to adjust the filter characteristics in response to the digital signal 162. In a non-depicted exemplary embodiment, the AICTR 170 may be implemented in a digital signal processor (DSP).

A gain or amplitude of the amplified filtered IF signal 152 is controlled by the AICTR 170 to operate the receiver 100 substantially close to saturation but without entering saturation. For example, by adjusting the gain to a value less than a threshold value at which a close-in interferer signal would saturate the receive path. The effective gain of the amplified filtered IF signal 152 is further improved without forcing the receiver 100 to operate in a saturated mode by increasing or decreasing the IF frequency f_{IF} of the IF signal 132 as described with reference to FIG. 2.

FIG. 2 is a graphical diagram illustrating amplitude versus frequency response characteristics 200 of the receiver 100 described with reference to FIG. 1, according to an embodiment. As described earlier, the input signal 102 includes the signal of interest, initially at a carrier frequency f_{c} and downconverted to the frequency f_{IF}, is illustrated by a graph 210. The interfering signal having a frequency f_{INT} 224 is illustrated by a graph 220. Frequency response characteristics of the LPF 140 filter are illustrated by a graph 230. The LPF 140 filter has an adjustable corner frequency of f_{3dB} 232 and has an adjustable slope S 234. As illustrated, amplitude of the graph 220 may be greater than amplitude of the graph 210 by a factor of approximately 70 dB to 80 dB as is the case in a GSM receiver. The Y-axis represents f_{IF} having a frequency value of zero (also referred to as zero-IF or DC value).

As the value of the f_{IF} is reduced and approaches a DC value, the graph 210 shifts towards the Y-axis and is illustrated by a graph 212. The f_{IF} frequency may be reduced to have a low value by either increasing the variable frequency of the LO signal 122 (for a low-side injection) or decreasing the variable frequency of the LO signal 122 (for a high-side injection). The IF frequency f_{IF} may be reduced to less than zero by continually increasing frequency of the LO signal 122 in the low side injection. The IF frequency f_{IF} may be made larger than zero by continually increasing frequency of the LO signal 122 in the high side injection. The reduction in f_{IF} also shifts the graph 220 away from the Y-axis and is illustrated by a graph 222. In a particular embodiment, an adjustment of the IF frequency f_{IF} is varied in accordance with the attenuation desired. The LO signal 122 frequency may be increased or decreased accordingly to operate the receiver substantially close to saturation but avoiding saturation. When a gain reduction is desired (e.g., when a point is reached where a close-in interferer may saturate the receive path), then instead of reducing the gain, the AICRT 170 reduces the IF frequency f_{IF} of the receiver 100. The reduction in f_{IF} results in additional filtering at the interferer frequency f_{INT}, 224 as is the case with graph 222. Thus, the shift of the graph 210 towards the Y-axis and graph 220 away from the Y-axis also provides a small gain to the signal of interest, while concurrently providing a higher rejection or attenuation to the large interferers.

In a particular embodiment, similar results and/or further improvements to the performance of the receiver 100 may also be obtained by adjusting the corner frequency f_{3dB} 232 and/or the slope S 234. That is, by lowering the corner frequency f_{3dB} 232 and/or by increasing the slope S 234, a small gain may be provided to the signal of interest, while concurrently providing a higher rejection or attenuation to the large interferers.

Receivers having a low value of IF frequency f_{IF} avoid the DC offset problems and are sensitive to 1/f noise associated with traditional zero-IF receivers. The technique of adjusting amplifier gain as well as the IF frequency f_{IF} implemented in the AICTR 170 provides benefits of reducing the level of the largest interferers, e.g., the interfering signal illustrated by the graph 220, and also decreasing the noise figure of the receiver 100 and thereby allowing a potential decrease in the receiver gain without increasing the original noise figure of the receiver. The AICTR 170 permits wider margins of errors about the AGC switching point and offer improved protection against process and temperature variations compared to traditional AGC techniques which provide the same attenuation to the signal of interest as well as the interfering signal. Therefore, the design considerations for analog implementation of AGC are less stringent in the receiver 100 compared to the traditional schemes, which may need more filtering and/or may need finer gain control steps.

FIG. 3 is a block diagram of an integrated receiver 300, according to an embodiment. In the depicted embodiment, the integrated receiver 300 implements a low-IF direct conversion architecture with quadrature components and delta sigma converter to facilitate single chip implementation while improving receiver performance. The integrated receiver 300 adjusts the intermediate frequency (IF) f_{IF} and the gain to improve receiver performance without saturating the receiver, similar to the receiver 100 described with reference to FIG. 1. The integrated receiver 300 is better suited to provide full integration with a single chip implementation compared to continuous signal analog implementations, which may use bulkier components. In the depicted embodiment, the integrated receiver 300 is a quad band receiver operable to receive a first input signal 302, a second input signal 304, a third input signal 306 and a fourth input signal 308.

Each one of the received signals 302-308 is amplified by a low noise amplifier (LNA), split into I/Q paths and converted to current domain using a transconductance amplifier (TA) stage. The current is then down-converted to a programmable low-IF frequency (e.g., 100 kilohertz) and integrated on a sampling capacitor at the LO rate. Considering plus and minus sides, each of the received input signal is sampled at the Nyquist rate of the RF carrier. After initial decimation through a Sinc ((Sin x)/x function) filter response, a series of infinite impulse response filtering follows RF sampling for close-in interferer rejection. These signal processing operations are performed in a multitap direct sampling mixer (MTDSM). Following the MTDSM, a sigma delta ADC includes a front-end gain stage for amplification and conversion to a digital signal.

Specifically, the integrated receiver 300 includes an analog front end (AFE) 310 circuit and an analog back end (ABE) 320 circuit which are discrete-time analog signal processing circuits to down-convert, downsample, filter and A/D convert the received signals 302-308. The AFE 310 includes low band (LB) and high band (HB) low noise amplifiers LNA LB and HB to receive the input signals 302-308. The signal is split into l/Q components and provided to transconductance amplifiers TA LBI/TA LBQ and TA HBI/TA HBQ for conversion to current domain and amplification. A multi-tap direct-sampling mixer (MTDSM) 380 provides filtered I/Q signals 382 to the ABE 320. The MTDSM 380 is a well known circuit that leverages the fast switching time and capacitor consistency to perform switched-capacitor filtering. The MTDSM 380 filters out most of the energy that is not of interest.

The ABE 320 performs amplification and A/D conversion. It includes continuous time amplifiers CTA LBI and CTA LBQ to receive the filtered I/Q signals 382 and passive sigma delta AND converter SD ADC for each I/Q channels. The ABE 320 provides a first digital signal 322 to a digital receiver (DRX) 330 to perform the downconversion to low-IF in digital domain. The digital receiver 330 provides RXI/RXQ 332 outputs to other devices such as a digital signal processor (DSP) 340 within the integrated receiver 300. The RXI/RXQ 332 outputs may be communicated to the DSP 340 via a well known communication standard such as open core protocol (OCP).

In a particular embodiment, the DSP 340 includes control logic 350 to perform functions substantially similar to the AICTR 170 described with reference to FIG. 1. That is, the control logic 350 monitors RSSI information and perform AGC functions such as adjusting the intermediate frequency (IF) f_{IF} and the gain to improve receiver performance without saturating the receiver.

In the depicted embodiment, the DSP 340 provides a LO control signal 342 to adjust frequency of low band I/Q signals LOLBI/LOLBQ and LOHBI/LOHBQ, a LNA control signal 344 to adjust a gain of the LNA LB and LNA HB, an ABE gain control signal 346 to adjust gain of continuous time amplifiers CTA LBI and CTA LBQ, and a transconductance amplifier/mixer TA/MIX control signal 348 to adjust gain of TA LBI/TA LBQ and TA HBI/TA HBQ in response to receiving the RXI/RXQ 332 outputs.

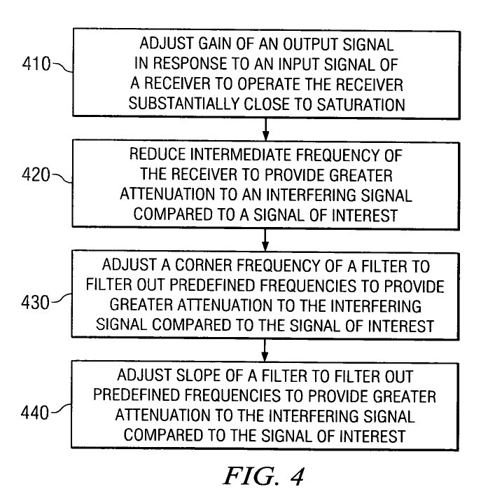

FIG. 4 is a flow chart illustrating a method for performing automatic gain control (AGC) in a receiver, according to an embodiment. In step 410, a gain of an output signal is adjusted in response to an input signal received by the receiver to operate the receiver substantially close to saturation but without saturating the receiver. In a particular embodiment, the receiver is substantially the same as the receiver 100 described with reference to FIG. 1 and/or the integrated receiver 300 described with reference to FIG. 3. The input signal includes a signal of interest and an interfering signal. At step 420, an intermediate frequency (IF) of the receiver is reduced to provide greater attenuation to the interfering signal compared to an attenuation for the signal of interest. In a particular embodiment, the IF is reduced by mixing the input signal having a first predefined frequency with a local oscillator (LO) signal having a variable second frequency, which is increased to reduce a difference between the first predefined frequency and the variable second frequency.

In an alternative embodiment, the IF f_{IF} is reduced by mixing the input signal having the first predefined frequency with the local oscillator (LO) signal having the variable second frequency, which is decreased to reduce a difference between the first predefined frequency and the variable second frequency. The value of IF frequency f_{IF} may be continuously varied from a positive value to a negative value. The variable second frequency is adjusted in accordance with the gain. For example, the variable second frequency is increased when the gain is increased to operate the receiver substantially close to the saturation.

Various steps described above may be added, omitted, combined, altered, or performed in different orders. For example, additional steps may be added to control filter characteristics such as corner frequency and slope. At step 430, a corner frequency of a filter included in the receiver is adjusted to filter out predefined frequencies of the input signal. The adjustment to the corner frequency provides greater attenuation to the interfering signal compared to the attenuation for the signal of interest. In step 440, a roll-off slope of a filter included in the receiver is adjusted to filter out predefined frequencies of the input signal. The adjustment to the roll-off slope provides greater attenuation to the interfering signal compared to the attenuation for the signal of interest.

Although illustrative embodiments have been shown and described, a wide range of modification, change and substitution is contemplated in the foregoing disclosure and in some instances, some features of the embodiments may be employed without a corresponding use of other features. Those of ordinary skill in the art will appreciate that the hardware and methods illustrated herein may vary depending on the implementation. For example, although the disclosure is described in the context of analog functions, this disclosure is not limited to use with analog technology; rather, it envisions use of analog (continuous time and discreet-time), digital and mixed mode signal processing technologies. As another example, although the disclosure is described in the context of a high-side injection receiver, the present disclosure is applicable in low-side injection receiver as well.

While the description focuses on radio devices based on the GSM standard, the present disclosure is applicable in other frequency bands using other technical standards, including proprietary standards. Therefore, the discussion should not be construed as limiting the present invention to GSM transceivers. For example, the present invention has application in global positioning systems (GPS), low-earth orbit satellite system based communications systems, geographic area wide wireless networks and other cellular based communications systems. The cellular based systems may include first, second, and third generation (and beyond) digital phone systems, time-division multiple access (TDMA), code-division multiple access (CDMA), Bluetooth technology along with other digital communications technologies operating at various carrier frequencies. Additionally, as described above, the transceiver device described in the present disclosure has application in wired transceivers as well.

The methods and systems described herein provide for an adaptable implementation. Although certain embodiments have been described using specific examples, it will be apparent to those skilled in the art that the invention is not limited to these few examples. The benefits, advantages, solutions to problems, and any element(s) that may cause any benefit, advantage, or solution to occur or become more pronounced are not to be construed as a critical, required, or an essential feature or element of the present disclosure.

The above disclosed subject matter is to be considered illustrative, and not restrictive, and the appended claims are intended to cover all such modifications, enhancements, and other embodiments which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. An automatic integrated controller (AICTR) device comprising:
a gain controller to control an amplitude of an output signal in response to an input signal, wherein the gain controller maintains the amplitude within a predefined range; and
a frequency controller to control a frequency of a local oscillator (LO) signal, wherein the LO signal when mixed with the input signal provides greater attenuation to an interfering signal compared to an attenuation for a signal of interest, wherein the interfering signal and the signal of interest are included in the input signal.

2. The device of claim 1, comprising:
a filter controller to adjust a corner frequency of a filter to filter out predefined frequencies of the input signal, wherein the filter controller adjusts the corner frequency to provide the greater attenuation to the interfering signal compared to the attenuation for the signal of interest.

3. The device of claim 1, comprising:
a filter controller to adjust a roll-off slope of a filter to filter out predefined frequencies of the input signal, wherein the filter controller increases the roll-off slope to provide the greater attenuation to the interfering signal compared to the attenuation for the signal of interest.

4. The device of claim 1, wherein the gain controller and the frequency controller are included in a receiver, wherein the amplitude is maintained within the predefined range to operate the receiver substantially close to saturation.

5. The device of claim 4, wherein the frequency of the LO signal is adjusted in accordance with a level of the interfering signal, wherein the frequency is increased when the level is increased to operate the receiver substantially close to saturation.

6. The device of claim 1, wherein each one of the gain controller and the frequency controller is implemented in a digital signal processor (DSP).

7. The device of claim 1, wherein the gain controller and the frequency controller is included in one of a microprocessor, a digital signal processor, a radio frequency integrated circuit, and a microcontroller.

8. The device of claim 1, wherein the LO signal when mixed with the input signal generates an intermediate frequency (IF) signal, wherein the frequency of the LO signal is increased to reduce a frequency of the IF signal, wherein a reduction in the frequency of the IF signal causes the greater attenuation to the interfering signal compared to the attenuation for the signal of interest.

9. The device of claim 1, wherein the LO signal when mixed with the input signal generates an intermediate frequency (IF) signal, wherein the frequency of the LO signal is decreased to reduce a frequency of the IF signal, wherein a reduction in the frequency of the IF signal causes the greater attenuation to the interfering signal compared to the attenuation for the signal of interest.

10. A receiver comprising:
a low noise amplifier (LNA) to receive an input signal and provide an amplified input signal, wherein the amplified input signal has an interfering signal and a signal of interest;
a local oscillator (LO) to provide a LO signal having a variable frequency;
a mixer to mix the amplified input and the LO signal to provide an intermediate frequency (IF) signal;
a low pass filter to receive the IF signal and provide a filtered IF signal after filtering out at least one of the interfering signal;
a variable gain amplifier (VGA) to receive the filtered IF signal and provide an amplified filtered IF signal having an amplitude within a predefined range;
an analog to digital converter (ADC) to convert the amplified filtered IF signal into a digital signal; and
an automatic integrated controller (AICTR) to monitor the digital signal, wherein the AICTR provides a LO control signal to adjust the variable frequency and an IF gain control signal to adjust the amplitude, wherein the LO control signal and the IF gain control signal are provided in response to the digital signal.

11. The receiver of claim 10, wherein the receiver is included in one of a microprocessor, a digital signal processor, a radio frequency integrated circuit, and a microcontroller.

12. The receiver of claim 10, wherein the AICTR is implemented in a digital signal processor (DSP).

13. The receiver of claim 10, wherein the AICTR provides a filter control signal to adjust a corner frequency of the low pass filter, wherein the filter control signal adjusts the corner frequency to provide greater attenuation to the interfering signal compared to the attenuation for the signal of interest.

14. The receiver of claim 13, wherein the filter control signal adjusts a roll-off slope of the low pass filter, wherein the roll-off slope is increased to provide greater attenuation to the interfering signal compared to the attenuation for the signal of interest.

15. A method for performing automatic integrated control in a receiver, the method comprising:
adjusting a gain of an output signal in response to an input signal received by the receiver, wherein the gain is adjusted to operate the receiver substantially close to saturation; and
reducing an intermediate frequency (IF) of the receiver, wherein reducing the IF provides greater attenuation to an interfering signal compared to an attenuation for a signal of interest, wherein the interfering signal and the signal of interest are included in the input signal.

16. The method of claim 15, wherein the IF is reduced by mixing the input signal having a first predefined frequency with a local oscillator (LO) signal having a variable second frequency, wherein the variable second frequency is decreased to reduce a difference between the first predefined frequency and the variable second frequency.

17. The method of claim 15, wherein the IF is reduced by mixing the input signal having a first predefined frequency with a local oscillator (LO) signal having a variable second frequency, wherein the variable second frequency is increased to reduce a difference between the first predefined frequency and the variable second frequency.

18. The method of claim 17, wherein the variable second frequency is adjusted in accordance with the gain, wherein the variable second frequency is increased when the gain is increased to operate the receiver substantially close to the saturation.

19. The method of claim 15, comprising:
adjusting a corner frequency of a filter included in the receiver to filter out predefined frequencies of the input signal, wherein the adjusting of the corner frequency provides greater attenuation to the interfering signal compared to the attenuation for the signal of interest.

20. The method of claim 15, comprising:
adjusting a roll-off slope of a filter included in the receiver to filter out predefined frequencies of the input signal, wherein the adjusting of the roll-off slope provides greater attenuation to the interfering signal compared to the attenuation for the signal of interest.
